(19) United States
(12) Patent Application Publication
(10) Pub. No.: US 2004/0024749 A1
(43) Pub. Date: Feb. 5, 2004

(54) Automated system and method for reviewing medical and financial claim records and for identifying missing devices and/or services associated with medical and financial procedures

(75) Inventor: Bruce Kusens, North Miami Beach, FL (US)

Correspondence Address: Daniel S. Polley, Esq., Malin, Haley & DiMaggio, P.A., 1936 South Andrews Avenue, Fort Lauderdale, FL, 33316, US

(73) Assignee: Omega Systems, Inc.

(21) Appl. No.: 10/209,710

(22) Filed: Aug. 1, 2002

(51) Int. Cl. G06F 17/60; G06F 7/00; G06F 17/30

(52) U.S. Cl. 707/3; 705/3

(57) ABSTRACT

This invention relates to a method and system that identifies pass-through items, medications and/or sub-procedures that are typically associated with the performance of medical procedures yet not listed on corresponding medical claim records. The invention includes the steps of storing a database of medical records on a first computer data storage medium, storing a database of event codes on a second computer data storage medium, and electronically transmitting the database of records to the second computer data storage medium. Each event code corresponds to a pass-through item, medication or sub-procedure. The invention analyzes a particular medical procedure and determines if an event code should be listed on the record corresponding to that particular medical procedure. If not, the invention transmits a report identifying the missing event code, and in one embodiment, generates a new record with the proper event code now properly listed. The transfer of claim record information, and any subsequent reports listing omitted event codes can be performed either automatically or at the user's request, via an intranet or Internet connection and allows the user to quickly determine which medical procedures listed in the claim records have omitted associated medical devices or sub-procedures, which, if listed, would be reimbursable to the medical facility.

### FIELD OF INVENTION

This invention relates to a method of identifying medical devices and/or sub-procedures associated with the performance of patient medical procedures yet not listed on corresponding medical insurance claim records, and more particularly to a method for identifying pass-through devices, drug and/or biologicals and subordinate procedures that may have been used or performed during the course of a medical procedure on a patient, but not claimed in insurance reimbursement requests.

### BACKGROUND OF THE INVENTION

The Federal government has recently implemented a revised payment methodology for medical insurance outpatient claims. The introduction of Ambulatory Payment Classifications (APCs) has forced hospitals and other health-providers to alter their methods of submitting medical claims to their insurance provider.

The changes implemented by the Federal government have created two inherent problems. First, APCs do not provide reimbursement for pass-through devices (devices implanted or inserted as an integral or subordinate part of a medical procedure). Instead pass-through items are billed as separate line items on the claim form. Therefore, pass-through charges for medical devices, drugs, biologicals, supplies and durable medical equipment must all be separately identified on the claim form via specially assigned reimbursement codes. The hospital or health-care provider assumes full responsibility for including any specialty code entries and all appropriate procedures on the claim and in the patient account. Second, of the thousands of medical procedures performed today, a vast number have ancillary procedures that typically accompany the primary procedure. For example, an upper GI endoscopy is typically not performed without a surgical pathology and either a bacterial culture or a pathology consultation. These additional procedures must also be billed as separate line items in order for the medical facility to receive payment. Combined, pass-through items and subordinate procedures can represent a significant portion of a medical facility's reimbursement total if properly billed and claimed.

Typically, the way to ensure accurate identification of pass-through devices is to physically review each medical record for the use of pass-through devices in conjunction with a medical procedure. The device must then be coded. However, codes often change. Further, knowing where and what to look for requires specially skilled employees and is far beyond the ability of most business office personnel. As a result, many claims omit pass-through devices and/or ancillary procedures. In the past, this was not significant, as the costs for these items became part of the cost report. Under the recent changes however, without the proper identification of pass-through devices and subordinate procedures on the claim form, medical facilities can forfeit thousands of dollars per day in medical insurance reimbursement.

Accordingly, what is needed in the art is a system and method for examining patient medical claim records, each record comprising a medical procedure and an event code, comparing each record to a matrix of current codes, wherein each code represents a pass-through device, drug or biological, or a subordinate procedures commonly associated with a given medical procedure, and determining if any records have omitted event codes, which should have been listed as part of the given procedure. The transfer of claim record information, and any subsequent reports listing omitted event codes can be performed either automatically or at the user's request, via an intranet or Internet connection and allows the user to quickly determine which medical procedures listed in the claim records have omitted associated medical devices or sub-procedures, which, if listed, would be reimbursable to the medical facility.

It is, therefore, to the effective resolution of the aforementioned problems and shortcomings of the prior art that the present invention is directed.

### SUMMARY OF THE INVENTION

The present invention comprises a method for reviewing a record for a claim to determine the possible omission of products and/or services routinely associated with the claim. The method comprises the steps of providing a record having one or more claims, providing a database of records wherein each of the claims is associated with one or more products and/or services, and identifying any product and/or service which are routinely associated with the claim that does not appear on the record.

In the preferred embodiment, the inventive method further comprises the steps of storing the database of records on a first computer data storage medium, storing a database of event codes on a second computer data storage medium, and electronically transmitting the database of records to the second computer data storage medium prior to the step of identifying any product and/or service which is routinely associated with the claim that does not appear on the record. In the preferred embodiment, the step of electronically transmitting the database of records to the second computer data storage medium is performed over the Internet.

In one embodiment, the inventive method further comprises the step of preparing a report listing the identified products and/or services that did not appearing on the record and electronically transmitting the report from the second computer data storage medium to the first computer data storage medium. In yet another embodiment of the present invention, the method further comprises the step of generating a second record including identified products and/or services not appearing on the record. The step of electronically transmitting the database of records may be performed upon a request by a user or performed automatically.

In an alternate embodiment of the invention, a method of automatically reviewing medical claim records is provided in order to determine the existence of omitted products and/or services routinely used in medical procedures. The method comprises the steps of providing a patient medical claim record, the record identifying medical procedures performed, providing a database of event codes wherein each of the event codes identifies products and/or services routinely used in conjunction with each medical procedure, and identifying the products and/or services listed in the database that has been omitted from the patient medical claim record.

In one embodiment of the invention, the event code identifies a pass-through device typically associated with a given medical procedure. In another embodiment, the event code identifies a pass-through drug or biological typically associated with a given medical procedure. In yet another embodiment, the event code identifies a subordinate procedure typically associated with a given medical procedure. However, in the preferred embodiment, a combination or all of these event code embodiments can be provided.

The method of the alternate embodiment described above may further include the step of preparing a report listing the identified products and/or services omitted during the performance of each medical procedure. A further embodiment includes the steps of verifying if the identified products and/or services were used in the corresponding medical procedure, and if the identified products and/or services were used in the corresponding medical procedure, generating a second record including event codes corresponding to the identified products and/or services not appearing on the record.

The method may further comprise the step of generating a second record reflecting identified products and/or services not appearing on the record.

The method may further comprise the steps of storing the patient medical claim record on a first computer data storage medium, storing the database of event codes on a second computer data storage medium, and electronically transmitting the patient medical claim record to the second computer data storage medium prior to the step of identifying the products and/or services listed in the database that have been omitted from the patient medical claim record. The step of electronically transmitting the one or more claim records is performed upon a request by a user or performed automatically.

Preferably, the step of electronically transmitting the patient medical claim record to the second computer data storage medium is performed over the Internet.

A report can be prepared listing the identified products and/or services omitted during the performance of each medical procedure. This report can be electronically transmitted from the second computer data storage medium to the first computer data storage medium.

In yet another embodiment, the invention represents a computer program stored in a computer readable medium embodying instructions to perform a method of automatically reviewing medical claim records to determine the existence of omitted products and/or services routinely used in medical procedures, the method comprising the steps of comparing a patient medical claim record identifying medical procedures performed, with a database of event codes, wherein each of said event codes identifies products and/or services routinely used in conjunction with each said medical procedure, and identifying the products and/or services listed in the database that has been omitted from the patient medical claim record.

The event code can identify a pass-through device typically associated with a given medical procedure, a pass-through drug or biological typically associated with a given medical procedure, and/or subordinate procedure typically associated with a given medical procedure.

In its preferred embodiment, the computer program further comprises the step of electronically transmitting the patient medical claim record from a first computer data storage medium to a second computer data storage medium prior to the step of identifying the products and/or services listed in the database that have been omitted from the patient medical claim record. Preferably, the step of electronically transmitting the patient medical claim record to the second computer data storage medium is performed over the Internet. The step of electronically transmitting the patient medical claim record can be performed upon a request by a user or performed automatically.

In another embodiment, the invention comprises a system of automatically reviewing medical claim records to determine the existence of omitted products and/or services routinely used in medical procedures. The system comprises means for providing a patient medical claim record, the record identifying medical procedures performed, means for providing a database of event codes wherein each of the event codes identifies products and/or services routinely used in conjunction with each medical procedure, and means for identifying the products and/or services listed in the database that has been omitted from the patient medical claim record.

The system may further include means for preparing a report listing the identified products and/or services omitted during the performance of each medical procedure and means for generating a second record reflecting identified products and/or services not appearing on the record.

In the system described above, the event code could identify a pass-through device typically associated with a given medical procedure, a pass-through drug or biological typically associated with a given medical procedure, and/or a subordinate procedure typically associated with a given medical procedure.

In one embodiment of the above-described system, means are provided for storing the patient medical claim record on a first computer data storage medium. Means are also provided for storing the database of event codes on a second computer data storage medium. Means may also be included for electronically transmitting the patient medical claim record to the second computer data storage medium. The Internet is the preferred means of electronically transmitting the claim record. In addition to transmission via the Internet, other wired and wireless technologies can be used, for all embodiments of the invention, such as wireless, satellite, cable, fiber optic, modem, etc.

In still another embodiment of the present invention, a method is provided for creating a rule governing the association of a medical procedure with an associated event code, the event code representing a device and/or procedure routinely used in the medical procedures. The method comprises the steps of providing a medical procedure, and associating one or more event codes with the medical procedure, wherein each event code corresponds to a device an/or procedure routinely used in the medical procedure.

The step of associating one or more event codes with the medical procedure can preferably comprise the steps of examining prior records listing the one or more medical procedures and their associated event codes, and statistically determining which event codes are most often associated with a given medical procedure. A further step for the method can include storing the created rule in a database.

It is therefore an object of the present invention to provide a system and method for reviewing a database of medical claim procedures and automatically identifying any product and/or services that are routinely associated with the medical procedure that does not appear on the record.

It is another object of the present invention to provide an automated system and method for automatically identifying missing sub-procedures and/or devises medical typically used in medical procedures and for seamlessly transmitting the information to and from the medical facility via the Internet.

It is to be understood that both the foregoing general description and the following detailed description are explanatory and are not restrictive of the invention as claimed. The accompanying drawings, which are incorporated in and constitute part of the specification, illustrate embodiments of the present invention and together with the general description, serve to explain principles of the present invention.

These and other important objects, advantages, and features of the invention will become clear as this description proceeds.

The invention accordingly comprises the features of construction, combination of elements, and arrangement of parts that will be exemplified in the description set forth hereinafter and the scope of the invention will be indicated in the claims.

### BRIEF DESCRIPTION OF THE DRAWINGS

For a fuller understanding of the nature and objects of the invention, reference should be made to the following detailed description, taken in connection with the accompanying drawings, in which:

FIG. 1 is a block diagram illustrating the overall data flow of the preferred embodiment of the present invention;

FIG. 2 is a sample medical claim record of the type used with the present invention illustrating a list of medical procedures for a particular patient;

FIG. 3 is a sample matrix listing procedure numbers, procedure descriptions and corresponding C-codes for pass-through items typically used with the corresponding procedure;

FIG. 4 is a diagram illustrating the data transmission flow of one embodiment of the present invention;

FIG. 5 is a revised claim record illustrating the inclusion of the proper event code after utilization of the present invention; and

FIG. 6 shows the step-by-step process taken by the one embodiment of the present invention.

### DETAILED DESCRIPTION OF THE PREFERRED EMBODIMENT

The invention is a data transfer system and method allowing for the automatic identification of missing event codes on patient medical claim records where the event codes correspond to devices, medications and/or other reimbursable pass-through items and/or procedures associated with standard medical procedures.

For example, surgery is performed on a patient with a fractured ankle to implant a plate and screws to hold the bone together. Therefore a medical procedure number corresponding to the ankle surgery appears on the patient's claim record. To insure that the fracture is appropriately reduced, the surgeon orders x-rays. The claim may generate without the ordering of x-rays indicated. The present invention screens the claim, identifies the missing items and/or procedures, and generates alerts warning the user of the omissions.

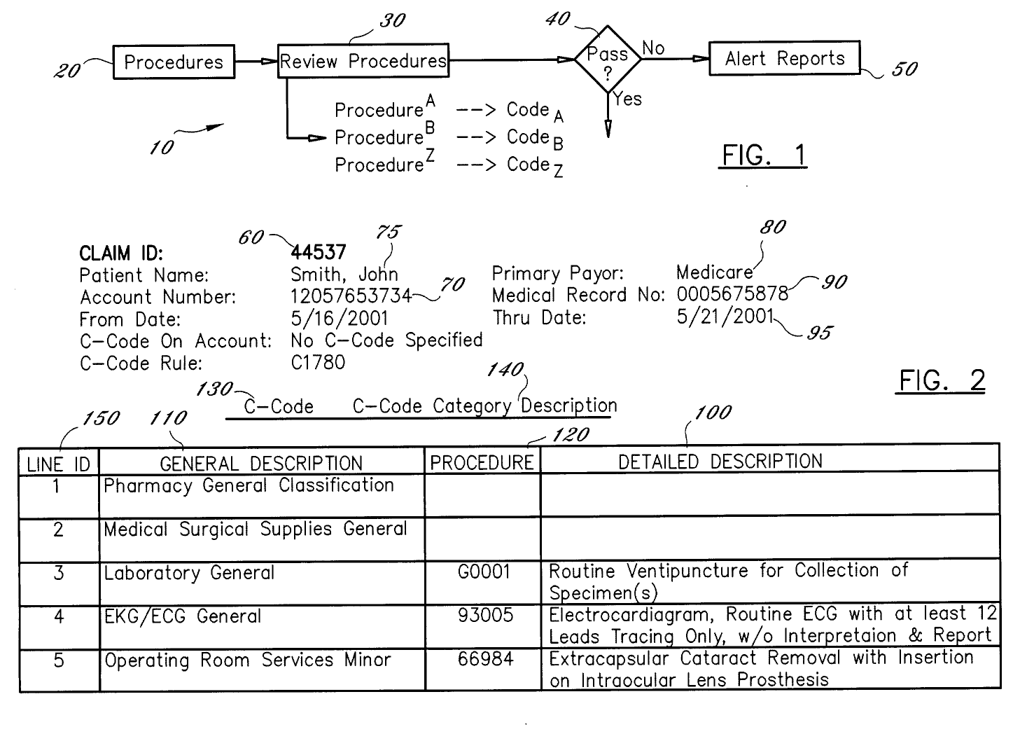

FIG. 1 shows the data flow in the preferred embodiment of the present invention 10. The data flow of FIG. 1 begins with a hospital, doctor's office, clinic, emergency service facility (e.g. paramedic, ambulance) and/or other medical facility or company compiling and storing a database of patient medical records on a computer, disk, tape, zip drive or other data storage medium, or on a server as part of an electrical communications network. This database can be updated frequently whenever a patient undergoes a medical procedure. In FIG. 1, a record of claims containing one or more medical procedures is shown as 20. The medical facility then compiles a listing of insurance claims by extracting the medical procedure information from the database. The claims are a listing of the medical procedures performed on a given patient over a predetermined time period. The listing of claims is prepared with the intention of forwarding them to the medical facility's insurer, for example Medicare.

The claim record is usually prepared in a format dictated by the insurer, and can provide the patient's name and account number, a listing of all the medical procedures performed on that patient, and an event code representing devices or sub-procedures typically associated with the medical procedure performed on the patient. Due to drastic changes in the way the Federal government implements the payment methodology for medical insurance outpatient claims, it has become critical to list all event codes associated with the main medical procedure, on the claim record. A typical claim record is shown in FIG. 2. It is to be noted that the claim record shown in FIG. 2 merely illustrates one way in which the patient's claim record may be configured, and should not be construed as being the only way. Any means of presenting patient medical information would be consistent with the scope of the invention.

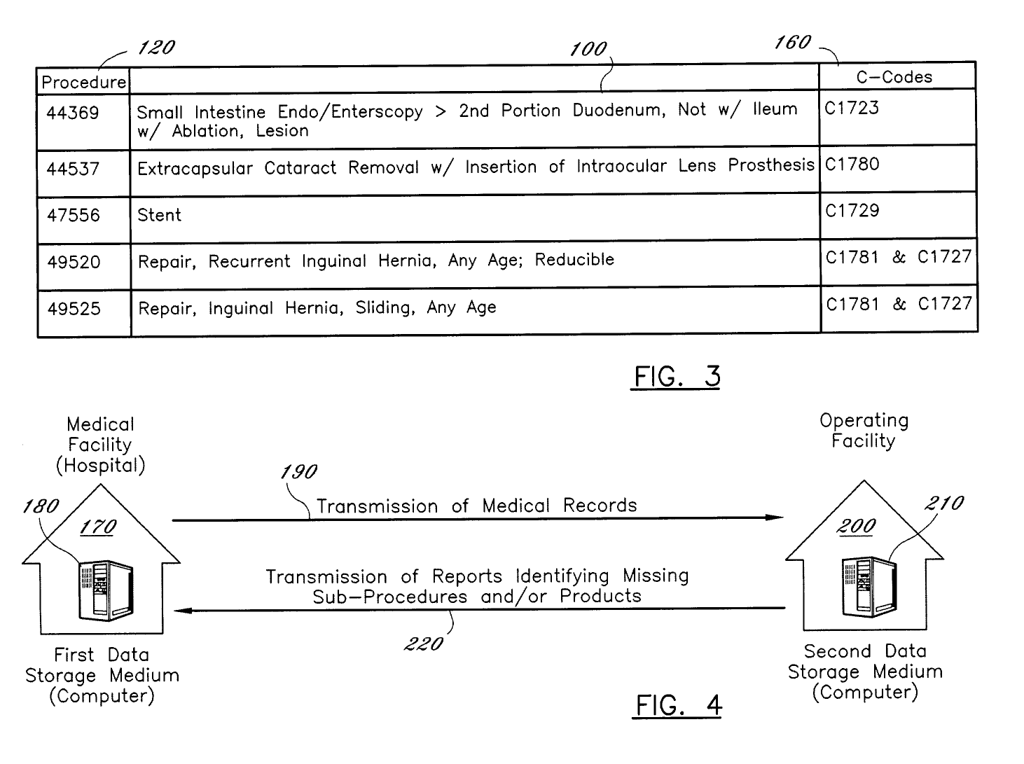

Referring again to FIG. 1, each medical procedure is accessed and compared to a database of medical procedures and corresponding event codes via step 30. A representative portion of the database is shown in FIG. 3. The database could be stored on any type of data storage medium such as a disk, tape, or zip drive, for example. The invention provides software that accesses each procedure listed on the claim form for a particular patient. The procedure could be accessed via any standard searching technique, such as by the name of the procedure or by the procedure code. The software then examines the database of procedures and corresponding codes, and determines if the medical claim being examined contains a procedure without a corresponding event code. If the procedure includes the proper event code, the system issues a “PASS”directive, step 40, and the next procedure can be examined. If an event code has been omitted from the claim record, the procedure, the claim record and the omitted event code is noted and this information can be stored for later generation of a report, step 50.

The event codes correspond to pass-through items such as devices, services, medications and/or sub-procedures that usually accompany the medical procedure. The report can be generated to alert the medical facility that event codes were omitted from the claim forms, thereby allowing the facilities to correct the claim form if needed, and supply the proper event code to its insurer in order to be properly reimbursed, as well as allowing the facilities to maintain proper quality control of its medical protocols.

The present invention provides a means for hospitals or other medical care providers to be properly reimbursed for the use of pass-through devices or procedures (and thus realize a profit) in the ever-changing world of Federal medical regulations. Because use of the invention results in the automatic identification of omitted devices and/or procedures that should have been utilized in a given medical procedure, it eliminates the need for: (1) an employee to manually check each medical procedure listed in a claim record, of which there could be thousands; (2) compare each procedure to a listing of event codes matched up to each procedure; (3) manually enter each procedure missing an event code; and (4) then re-generate the claim record; a tedious and inefficient method currently being undertaken in the field.

Another benefit that may result from implementation of the invention is assuring that medical procedures are being performed according to proper medical protocols, using the latest technological devices and sub-procedures. By constantly updating the event codes to coincide with the latest medical discoveries and technological breakthroughs, medical care providers can automatically monitor its doctors, surgeons, nurses and hospital staff to assure that all medical procedures are being performed properly, safely and efficiently. Thus, the invention is also a quality control tool tailored to determine which doctors and/or assistants are not following clinical protocol.

Alternately, the invention could be used as a method of insuring that doctors, surgeons and medical staff members are aware of the proper pass-through items, medications and the appropriate sub-procedures that are to be used or performed with a given medical procedure. For example, prior to performing a medical procedure, a surgeon can query the procedure/event code database and request a particular medical procedure. He will be provided all the devices and sub-procedures that are typically used during the performance of the requested medical procedure. In this fashion, the surgeon and his staff can quickly insure that all of the proper medications are at hand during the surgery, and that all sub-procedures will be performed according to proper protocol.

A typical claim record of the type used in the present invention is shown in FIG. 2. This claim record used by way of example and is by no means illustrative of the only type of claim record that can be used with the invention. A Claim ID Number 60 corresponds to a particular patient 75, in this case John Smith. The patient's account number 70 and insurer 80 can also be listed, along with the medical record number 90 and the time frame covered by claim record 95. The latest procedure performed on the patient is then described in section 100.

In the particular case illustrated in FIG. 2, a general medical procedure description 110 is given as “OPERATING ROOM SERVICES MINOR”, followed by a procedure number 120. A more detailed description of the medical procedure 100 follows. In this case, the patient underwent a cataract removal procedure including the insertion of an intraocular lens prosthesis. Because an intraocular lens is a pass-through item, and if used during a medical procedure, the hospital should be reimbursed for its use by its insurance provider. An event code 130 and its corresponding description 140, i.e. an “intraocular lens” should therefore be listed. In this example no event code appears on the record for the intraocular lens.

Below the location where a C-code is supposed to be provided, is an up-to-date listing of all medical procedures performed on the given patient, the procedure number and a detailed description of the procedure. Line ID 150 identifies the various procedures performed on the patient. General descriptions 110, procedure numbers 120 and detailed descriptions 100 of each procedure are listed. The most recent procedure performed appears as the highest Line ID number, 5, in this case.

FIG. 3 illustrates a portion of a sample database used in the present invention to list medical procedures and corresponding event codes. In this example, a listing of C-codes is provided in column 160. Each medical procedure indicated by its procedure number 120, has one or more corresponding C-codes associated with it. The C-code can represent a pass-through item, such as implanted or inserted devices, drugs or biologicals, or sub-procedures performed commonly used in the given medical procedure. In this example, Procedure number 44537, corresponding to “EXTRACAPSULAR CATARACT REMOVAL W/INSERTION OF INTRAOCULAR LENS PROTHSTESIS” is listed in the second row in FIG. 3. C-Code C1780 is listed for this procedure. Yet by examining the claim records listing in FIG. 2, C-Code C1780 is not listed for this procedure. If the device corresponding to this C-Code, in this case, an intraocular lens, was actually used during the medical procedure performed on the patient, the medical facility would not be reimbursed by the insurer due to the recent rule changes enacted by the Federal government and the omission of the C-code. The present invention automatically and seamlessly flags this omission, and in one embodiment, generates a report informing the medical facility of the omission, and, in another embodiment, regenerates new medical claim reports, with the additional C-code now properly inserted.

One of the distinct advantages of the present invention is its almost nonexistent interference with normal daily processes. FIG. 4 illustrates a preferred embodiment of the invention. Here, a medical facility 170 contains one or more patient medical claim records, stored in a first, computer data storage medium 180. The information is then transmitted, preferably via an intranet or Internet connection 190 to a second location 200, where the information is stored in a second computer data storage medium 210. Although the Internet is the preferred means of electronically transmitting the claim record, all other varied wired and wireless technologies can be used, for all embodiments of the invention, such as wireless, satellite, cable, fiber optic, modem etc.

The information can be sent either upon the request of the facility or automatically, such as at pre-determined intervals. After the omitted event codes have been identified, the facility is notified, preferably by a report transmitted to the medical facility via the Internet or via other transmittal means 220. Again, the use of other wired and wireless technologies are within the scope of all embodiments of the invention, for example, wireless, satellite, cable, modem, and fiber optic, technologies. The report can identify all of the omitted event codes that should have been listed in the medical records provided. Facility 170 can then check to see if the omitted devices and/or sub-procedures were in fact used by the facility in the medical procedure and if so, re-generate new claim records reflecting the missing event codes.

Once the omitted event codes have been identified and new medical claim records re-generated to reflect the missing event codes, the medical facility can now send out its revised claim records to its insurance provider, Medicare for example.

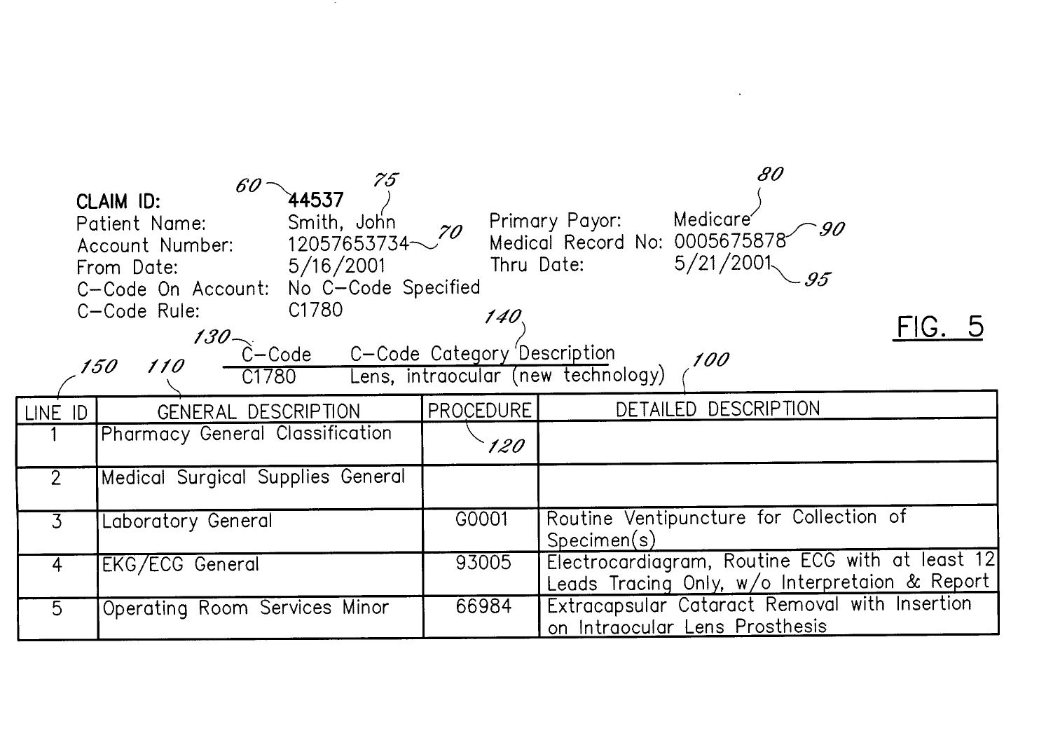

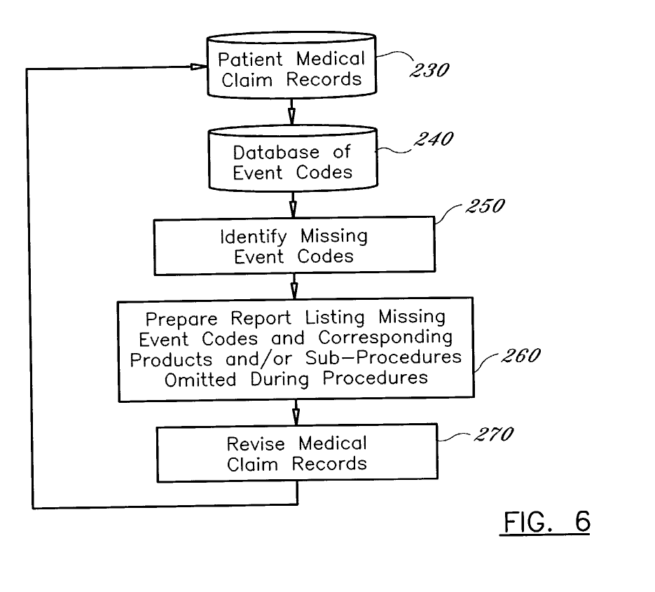

Referring now to FIG. 5, a portion of a claim report is shown after utilization of the present invention. After the omitted event code has been detected and medical facility 170 notified, a revised report can be generated with C1780 now listed as the C-Code 130 along with its corresponding C-Code category description 140, in this case: “Lens, Intraocular”. The event code, in this case is a “C-Code”, describes a pass-through device commonly used in the listed procedure. The event code could be virtually any type of identifier corresponding to a medical device and/or sub-procedure typically used in the given medical procedure.

In the illustrated example of FIG. 5, it is logical that a new lens needed to be inserted in the patient's eye after the removal of a cataract. However, if the C-code was not listed along with the cataract removal procedure, as shown in the original claim record of FIG. 2, and if the new lens was actually inserted, the hospital would not be reimbursed by Medicare for the inserted lens. The invention automatically eliminates this problem, seamlessly, without the need for additional employee time. Further, there is the chance that the procedure was performed without the insertion of a new lens. The automated verification procedure of the present invention would therefore also help detect and identify improper medical protocols.

FIG. 6 is a block diagram illustrating the steps performed by the preferred embodiment of the present invention. A database of medical claim records 230 stores information for each patient, including medical procedures performed. The information is accessed and compared with a second database of standard primary medical procedures and corresponding event codes 240. The event codes define devices and/or procedures commonly used or performed along with the primary procedure. Any event codes not listed on the claim record is identified via step 250 and a report is prepared listing the missing event codes 260. After it has been verified that the identified device and/or procedure was indeed used/performed in the primary procedure, the database of patient medical records can then be revised to include the omitted items, at step 270.

The invention has a variety of modes, including: (1) manual mode; (2) an automated daily cycle mode; and (3) a retrospective mode. To use the manual mode, a medical facility or other company uses the Internet to access a web site, which contains the various medical records for that facility. A program can then encrypt and transmit the record file to a server. Logic routines can isolate appropriate claims and detect the appropriate procedure codes that should also be billed. With the appropriate processor, memory and disk space, a single file of over 6,000 claims can be processed in minutes. Reports are then generated or made available directly on the Internet for the medical facility.

In the automated daily cycle, processing takes place automatically without user intervention. A patient accounting system drops the claim file to a pre-specified directory. The file is then picked up and forwarded to a server where the processing cycle is performed automatically; either daily, or at any pre-determined intervals.

In the retrospective mode, claim histories can be analyzed. The user places all of the claim history files in a single directory. A program then transmits all of these files to a server, where the processing procedure begins.

The invention also provides a method of creating a rule, or standard, governing the association of a standard medical procedure with an associated event code, where the event code represents a device and/or procedure routinely used in the standard medical procedure. A database is created where numerous medical procedures are stored and then analyzed to determine what devices, medications, biologicals and sub-procedures are typically associated with the primary medical procedure. By the use of statistical analysis, it can be determined how often certain pass-through items or procedures are used during the performance of the primary procedure. An event code database can then be constructed and used in conjunction with the present invention as described above and in the claims below.

As medical procedures change and new ways of performing a procedure is developed, the event codes may also change, and the event code database can be revised or updated. However, the method of creating the rule remains the same. Further, as new procedures are developed, they can be added to the database, and after time, new event code associations can be created. The end result is a dynamic system that will constantly notify medical care providers if their claim records are omitting items that would otherwise entitle them to financial compensation as well as informing them if their doctors and other medical practitioners and/or assistants are following standard medical and professional protocol.

The invention is not limited to the medical or financial fields. For example, the invention may be utilized by a plumber performing a task within a home. The plumber can quickly determined what ancillary devices and/or procedures must be used while performing the task. Builders, electricians and others can also utilize the invention with respect to their particular services.

It will be seen that the objects set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

What is claimed is:

1. A method for reviewing a record for a claim to determine the possible omission of products and/or services routinely associated with the claim, said method comprising the steps of:
providing a record having one or more claims;
searching a database of records wherein each said one or more claims is associated with one or more products and/or services; and
identifying any product and/or service which are routinely associated with the claim that does not appear on the record.

2. The method of claim 1 further comprising the step of preparing a report listing said identified products and/or services not appearing on the record.

3. The method of claim 1 further comprising the step of generating a second record including identified products and/or services not appearing on the record.

4. The method of claim 1 further comprising the steps of:
storing said database of records on a first computer data storage medium;
storing a database of event codes on a second computer data storage medium; and
electronically transmitting said database of records to said second computer data storage medium prior to said step of identifying any product and/or service which is routinely associated with the claim that does not appear on the record.

5. The method of claim 4 wherein the step of electronically transmitting said database of records is performed upon a request by a user.

6. The method of claim 4 wherein the step of electronically transmitting said database of records is performed automatically.

7. The method of claim 4 wherein said step of electronically transmitting said database of records to said second computer data storage medium is performed over the Internet.

8. The method of claim 4 further comprising the step of preparing a report listing said identified products and/or services not appearing on the record.

9. The method of claim 8 comprising the step of electronically transmitting the report from the second computer data storage medium to the first computer data storage medium.

10. A method of automatically reviewing medical claim records to determine the existence of omitted products and/or services routinely used in medical procedures, said method comprising the steps of:
providing a patient medical claim record, said record identifying medical procedures performed;
providing a database of event codes wherein each of said event codes identifies products and/or services routinely used in conjunction with each said medical procedure; and
identifying said products and/or services listed in the database that has been omitted from the patient medical claim record.

11. The method of claim 10 further comprising the step of preparing a report listing said identified products and/or services omitted during the performance of each said medical procedure.

12. The method of claim 11 further comprising the steps of:
verifying if the identified products and/or services were used in the corresponding medical procedure; and
if the identified products and/or services were used in the corresponding medical procedure,
generating a second record including event codes corresponding to the identified products and/or services not appearing on the record.

13. The method of claim 10 wherein said event code identifies a pass-through device typically associated with a given medical procedure.

14. The method of claim 10 wherein said event code identifies a pass-through drug or biological typically associated with a given medical procedure.

15. The method of claim 10 wherein said event code identifies a subordinate procedure typically associated with a given medical procedure.

16. The method of claim 10 further comprising the steps of:
storing said patient medical claim record on a first computer data storage medium;
storing said database of event codes on a second computer data storage medium; and
electronically transmitting said patient medical claim record to said second computer data storage medium prior to said step of identifying said products and/or services listed in the database that have been omitted from the patient medical claim record.

17. The method of claim 16 wherein the step of electronically transmitting said one or more claim records is performed upon a request by a user.

18. The method of claim 16 wherein the step of electronically transmitting said patient medical claim record is performed automatically.

19. The method of claim 16 wherein said step of electronically transmitting said patient medical claim record to said second computer data storage medium is performed over the Internet.

20. The method of claim 16 further comprising the step of preparing a report listing said identified products and/or services omitted during the performance of each said medical procedure.

21. The method of claim 20 further comprising the step of electronically transmitting the report from the second computer data storage medium to the first computer data storage medium.

22. The method of claim 20 further comprising the steps of:
verifying if the identified products and/ore services were used in the corresponding medical procedure; and
if the identified products and/or services were used in the corresponding medical procedure,
generating a second record including event codes corresponding to the identified products and/or services not appearing on the record.

23. A computer program stored in a computer readable medium, embodying instructions to perform a method of automatically reviewing medical claim records to determine the existence of omitted products and/or services routinely used in medical procedures, said method comprising the steps of:
comparing a patient medical claim record, said record identifying medical procedures performed, with a database of event codes, wherein each of said event codes identifies products and/or services routinely used in conjunction with each said medical procedure; and
identifying said products and/or services listed in the database that has been omitted from the patient medical claim record.

24. The computer program of claim 23 wherein said event code identifies a pass-through device typically associated with a given medical procedure.

25. The computer program of claim 23 wherein said event code identifies a pass-through drug or biological typically associated with a given medical procedure.

26. The computer program of claim 23 wherein said event code identifies a subordinate procedure typically associated with a given medical procedure.

27. The computer program of claim 23 further comprising the step of electronically transmitting said patient medical claim record from a first computer data storage medium to a second computer data storage medium prior to said step of identifying said products and/or services listed in the database that have been omitted from the patient medical claim record.

28. The computer program of claim 27 wherein the step of electronically transmitting said patient medical claim record is performed upon a request by a user.

29. The computer program of claim 27 wherein the step of electronically transmitting said patient medical claim record is performed automatically.

30. The computer program of claim 27 wherein said step of electronically transmitting said patient medical claim record to said second computer data storage medium is performed over the Internet.

31. A system of automatically reviewing medical claim records to determine the existence of omitted products and/or services routinely used in medical procedures, said system comprising:
means for providing a patient medical claim record, said record identifying medical procedures performed;
a database of event codes wherein each of said event codes identifies products and/or services routinely used in conjunction with each said medical procedure; and
means for identifying said products and/or services listed in the database that has been omitted from the patient medical claim record.

32. The system of claim 31 further comprising means for preparing a report listing said identified products and/or services omitted during the performance of each said medical procedure.

33. The system of claim 31 further comprising means for generating a second record reflecting identified products and/or services not appearing on the record.

34. The system of claim 31 wherein said event code identifies a pass-through device typically associated with a given medical procedure.

35. The system of claim 31 wherein said event code identifies a pass-through drug or biological typically associated with a given medical procedure.

36. The system of claim 31 wherein said event code identifies a subordinate procedure typically associated with a given medical procedure.

37. The system of claim 31 further comprising:
means for storing said patient medical claim record on a first computer data storage medium;
means for storing said database of event codes on a second computer data storage medium; and
means for electronically transmitting said patient medical claim record to said second computer data storage medium.

38. The system of claim 37 wherein said means for electronically transmitting said patient medical claim record to said second computer data storage medium is the Internet.

39. The system of claim 38 comprising means for preparing a report listing said identified products and/or services omitted during the performance of each said medical procedure.

40. The system of claim 39 further comprising means for electronically transmitting the report from the second computer data storage medium to the first computer data storage medium.

41. A method for creating a rule governing the association of a medical procedure with an associated event code, said event code representing a device and/or procedure routinely used in the medical procedures, the method comprising the steps of:
selecting a medical procedure; and
associating one or more event codes with said medical procedure, each said event code corresponding to a device an/or procedure routinely used in said medical procedure.

42. The method of claim 41 wherein said step of associating one or more event codes with said medical procedure comprises the steps of:
examining prior records listing said one or more medical procedures and their associated event codes; and
statistically determining which event codes are most often associated with a given medical procedure.
